(19) United States
(12) Patent Application Publication
(10) Pub. No.: US 2026/0229932 A1
(43) Pub. Date: Aug. 6, 2026

(54) Stator Structure and Fan Motor

(71) Applicant: FOSHAN SHUNDE LEPUDA MOTOR CO., LTD., Foshan, Guangdong (CN)

(72) Inventors: Dongkun Peng, Foshan, Guangdong (CN); Wulin Chen, Foshan, Guangdong (CN); Haibin Wen, Foshan, Guangdong (CN); Luowei Liang, Foshan, Guangdong (CN)

(21) Appl. No.: 19/147,712

(22) PCT Filed: Aug. 16, 2024
(86) PCT No.: PCT/CN2024/112725

§ 371 Date: Jul. 14, 2025

(30) Foreign Application Priority Data
Jul. 4, 2023 (CN) 202321730198.X

(51) Int. Cl. H02K 1/18; H02K 1/14; H02K 5/22

(52) U.S. Cl. CPC H02K 1/18; H02K 1/146; H02K 5/22

(57) ABSTRACT

The present utility model belongs to the technical field of motors, and discloses a stator structure and a fan motor. The stator structure includes a core, a frame, a winding, a wire holder, and a plastic package body. According to the stator structure and the fan motor provided by the present utility model, by arranging the positioning part exposed from the core at the edge of the frame, and also arranging the mounting part matching the positioning part on the wire holder, the wire holder can be fixed to the frame, so that the wire holder does not need to be pushed into an injection mold cavity manually during injection molding to ensure a quality of the stator structure.

### TECHNICAL FIELD

The present utility model belongs to the technical field of motors, and in particular to a stator structure and a fan motor.

### BACKGROUND

Motors are widely used in various electrical devices in industrial production and daily life. In order to extend the service life of motors and enable motors to be used in harsh environments, stators are usually sealed with plastic packages by an injection molding technology. However, when a stator is sealed with a plastic package, the package covering outside lead wires is prone to melt at a high temperature, resulting in electric leakage. To prevent this case from happening, a wire holder is used in the prior art to hold the lead wires to prevent the package covering outside the lead wires from melting. However, the wire holder needs to be manually pushed into an injection mold cavity during injection molding, and manual pushing cannot guarantee a predetermined position of the wire holder in the injection mold cavity, thus affecting a quality of the stator.

Therefore, the prior art has yet to be improved and developed.

### SUMMARY

An objective of the present utility model is to provide a stator structure and a fan motor, which can ensure a quality of the stator structure.

In a first aspect, the present utility model provides a stator structure, including a core, a frame, a winding, a wire holder, and a plastic package body, where the frame is arranged on the core, the winding is wound on the frame, an edge of the frame is provided with a positioning part, the positioning part is exposed from the core, the wire holder is provided with a mounting part, the mounting part is mounted on the positioning part, and the plastic package body covers the core, the frame, the winding, and the wire holder.

According to the stator structure provided by the present utility model, by arranging the positioning part exposed from the core at the edge of the frame, and also arranging the mounting part matching the positioning part on the wire holder, the wire holder can be fixed to the frame, so that the wire holder does not need to be pushed into an injection mold cavity manually during injection molding to ensure a quality of the stator structure.

Further, the above positioning part includes a positioning groove, the mounting part includes a mounting insert block, and the mounting insert block is inserted into the positioning groove.

In the present utility model, the wire holder can be fixedly mounted on the frame quickly by the positioning groove cooperating with the mounting insert block.

Further, the above positioning part further includes positioning plates, the mounting part further includes mounting grooves, and the positioning plates are inserted into the mounting grooves.

In the present utility model, the wire holder is mounted on the frame more firmly by the positioning plates cooperating with the mounting grooves.

Further, a number of the above positioning plates is two, and a number of the mounting grooves is also two. The two positioning plates are arranged on two sides of the positioning groove respectively, and the two mounting grooves are formed on two sides of the mounting insert block respectively.

Further, the above positioning part includes two positioning pins, the mounting part includes two mounting holes, and the two positioning pins are inserted into the two mounting holes respectively.

Further, the above wire holder includes a first holder and a second holder detachably connected to each other, and wire slots matching lead wires in shape are formed on one side of the first holder and one side of the second holder opposite to each other.

Further, insertion holes are formed in the above first holder, inserted pins are arranged on the second holder, and the inserted pins are inserted into the insertion holes.

Further, inner walls of the above insertion holes are provided with inwardly protruding blocking rings, ends of the inserted pins away from the second holder are provided with connecting heads, and the connecting heads are clamped by the blocking rings.

Further, the above connecting heads include multiple elastic connecting blocks. When the connecting heads pass through the blocking rings, the multiple connecting blocks can contract inward.

In a second aspect, the present utility model provides a fan motor, including a housing, a rotor, and a oscillation gearbox, and the stator structure as described in the first aspect above, where the housing is arranged on the core and covers the plastic package body, the rotor is rotationally arranged on an inner side of the core, a shaft of the rotor passes through the housing, and the oscillation gearbox is arranged on the housing and connected to the shaft of the rotor.

Based on the above, according to the stator structure and the fan motor provided by the present utility model, by arranging the positioning part exposed from the core at the edge of the frame, and also arranging the mounting part matching the positioning part on the wire holder, the wire holder can be fixed to the frame, so that the wire holder does not need to be pushed into an injection mold cavity manually during injection molding to ensure the quality of the stator structure.

Other characteristics and advantages of the present utility model will be described in the following specification, and moreover, will partly become obvious in the specification, or be understood by implementing the present utility model. The objective and other advantages of the present utility model may be implemented and obtained from the structures specifically indicated in the specification and drawings.

### BRIEF DESCRIPTION OF FIGURES

FIG. 1 is a schematic structural diagram of a stator structure provided in an embodiment of the present utility model.

FIG. 2 is a schematic structural diagram of the stator structure, with a plastic package body removed, provided in an embodiment of the present utility model.

FIG. 3 is a cross-sectional view of the stator structure, with the plastic package body removed, provided in an embodiment of the present utility model.

FIG. 4 is a schematic structural diagram of a wire holder provided in an embodiment of the present utility model.

FIG. 5 is a schematic structural diagram of anther stator structure, with a plastic package body removed, provided in an embodiment of the present utility model.

FIG. 6 is a cross-sectional view of the other stator structure, with the plastic package body removed, provided in an embodiment of the present utility model.

FIG. 7 is a schematic exploded view of the wire holder provided in an embodiment of the present utility model.

FIG. 8 is a cross-sectional view of the wire holder provided in an embodiment of the present utility model.

FIG. 9 is a schematic structural diagram of a fan motor provided in an embodiment of the present utility model.

FIG. 10 is a cross-sectional view of the fan motor provided in an embodiment of the present utility model.

List of reference numerals: 1, Core; 2, Frame; 21, Positioning part; 211, Positioning groove; 212, Positioning plate; 213, Positioning pin; 3, Winding; 4, Wire holder; 41, Mounting part; 411, Mounting insert block; 412, Mounting groove; 413, Mounting hole; 5, Plastic package body; 6, First holder; 61, Insertion hole; 611, Blocking ring; 7, Second holder; 71, Inserted pin; 711, Connecting head; 7111, Connecting block; 8, Housing; 9, Rotor; and 10, Reduction gearbox.

### DETAILED DESCRIPTION

Implementations of the present utility model are described in detail below, and the examples of the implementations are illustrated in the drawings, where the same or similar reference numerals throughout indicate the same or similar elements or elements having the same or similar functions. The implementations described below with reference to the drawings are exemplary, only intended to be illustrative of the present utility model and not to be construed as limiting to the present utility model.

In the description of the present utility model, it should be understood that orientation or position relationships indicated by terms such as “center”, “longitudinal”, “transverse”, “length”, “width”, “thickness”, “above”, “below”, “front”, “back”, “left”, “right”, “vertical”, “horizontal”, “top”, “bottom”, “inside”, “outside”, “clockwise”, and “anticlockwise” are based on orientation or position relationships shown in the drawings, and are intended to facilitate the description of the present utility model and simplify the description only, rather than indicating or implying that the apparatus or element referred to must have a particular orientation or be constructed and operated in a particular orientation, and therefore cannot be construed as a limitation to the present utility model. In addition, terms “first” and “second” are used merely for the purpose of description, and should not be construed as indicating or implying relative importance or implying a quantity of indicated technical features. Therefore, features defined by “first” and “second” may explicitly or implicitly include one or more of the features. In the description of the present utility model, “a plurality of” means two or more, unless otherwise explicitly and specifically defined.

In the description of the present utility model, it should be noted that unless otherwise explicitly specified or defined, the terms such as “mount”, “link”, and “connect” should be understood in a broad sense. For example, a connection may be a fixed connection, a detachable connection, or an integral connection; a mechanical connection, an electrical connection, or intercommunication; or a direct connection, an indirect connection through an intermediate, internal communication between two elements, or an interaction relationship between two elements. Those of ordinary skill in the art may understand specific meanings of the above terms in the present utility model according to specific situations.

In the present utility model, unless otherwise explicitly specified and defined, a first feature being “above” or “below” a second feature may include the first and second features being in direct contact, or may include the first and second features being not in direct contact but in contact through another feature therebetween. In addition, a first feature being “on”, “above”, or “over” a second feature includes the first feature being right above or obliquely above the second feature, or merely indicates the horizontal height of the first feature being greater than that of the second feature. A first feature being “below”, “under”, and “beneath” of a second feature includes the first feature being right below and obliquely below the second feature, or simply indicates the horizontal height of the first feature being less than that of the second feature.

The following disclosure provides many different implementations or examples for implementing different structures of the present utility model. In order to simplify the disclosure of the present utility model, components and arrangements of specific examples are described below. Of course, they are merely examples and are not intended to limit the present utility model. In addition, the present utility model may repeat reference numbers and/or reference letters in different examples, and such repetition is for the purpose of simplicity and clarity, and does not indicate a relationship between various implementations and/or arrangements discussed. In addition, the present utility model provides examples of various specific processes and materials, but those of ordinary skill in the art may realize application of other processes and/or use of other materials.

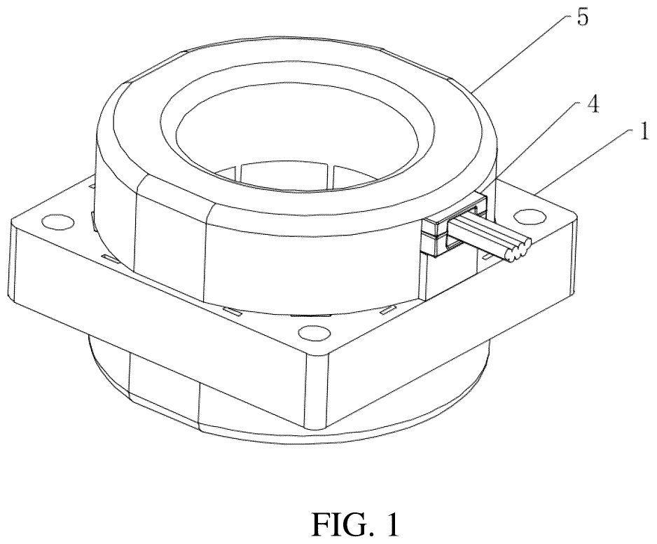

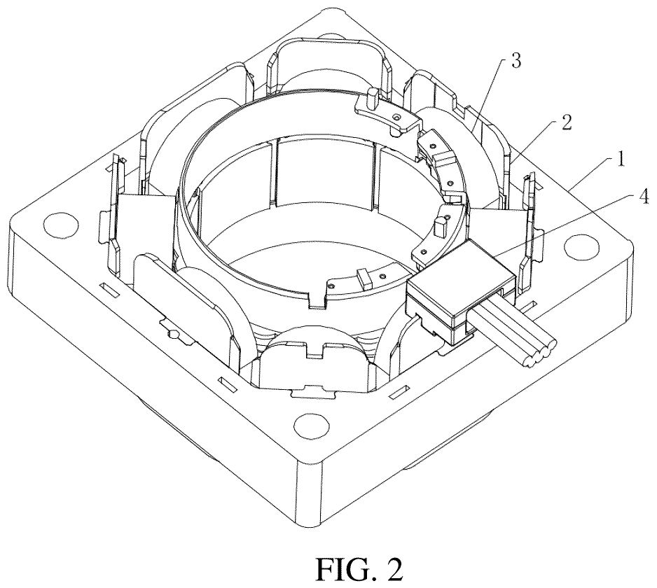

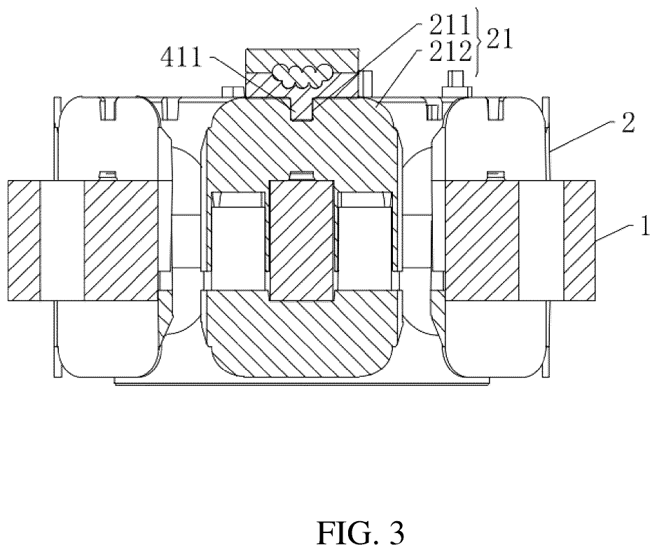

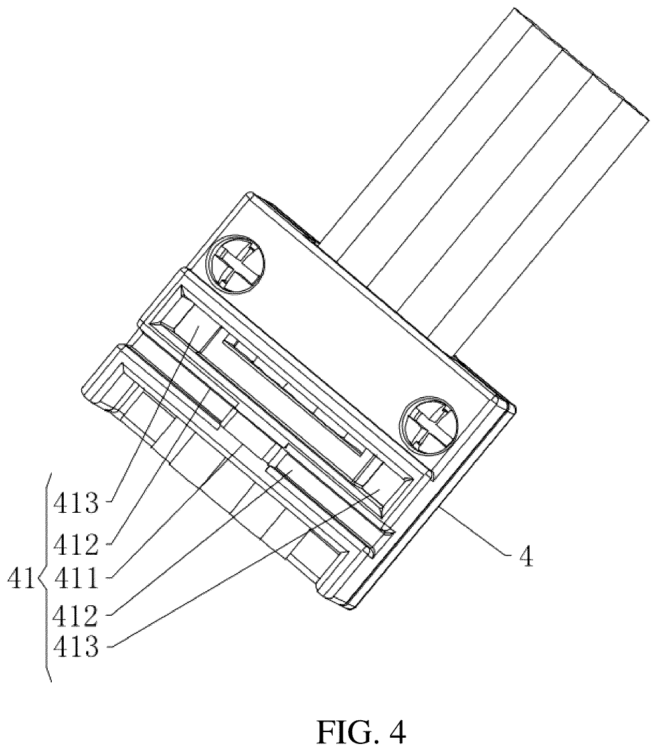

In a first aspect, as shown in FIG. 1, FIG. 2, FIG. 3, and FIG. 4, the present utility model provides a stator structure, including a core 1, a frame 2, a winding 3, a wire holder 4, and a plastic package body 5. The frame 2 is arranged on the core 1. The winding 3 is wound on the frame 2. An edge of the frame 2 is provided with a positioning part 21. The positioning part 21 is exposed from the core 1. The wire holder 4 is provided with a mounting part 41. The mounting part 41 is mounted on the positioning part 21. The plastic package body 5 covers the core 1, the frame 2, the winding 3, and the wire holder 4.

In a specific application, first, the core 1, the frame 2, and the winding 3 are assembled to obtain an assembly I. Then, lead wires of the assembly I are fixed with the wire holder 4, and the mounting part 41 of the wire holder 4 is mounted on the positioning part 21 of the frame 2 to obtain an assembly II. Finally, the assembly II is placed in an injection mold cavity for performing injection molding, to form a plastic package body 5 covering the core 1, the frame 2, the winding 3, and the wire holder 4 outside the assembly II, and obtain the stator structure.

By the technical solution, the wire holder 4 can be fixed to the frame 2, so that the wire holder 4 does not need to be pushed into the injection mold cavity manually during injection molding to ensure the quality of the stator structure.

It should be noted that there are two manners to assemble the core 1, the frame 2, and the winding 3 to obtain the assembly I. In one manner, first, the frame 2 is mounted on the core 1, and then the winding 3 is wound on the frame 2, which is called inner winding. In the other manner, first, the winding 3 is wound on the frame 2, and then mounted on the core 1, which is called outer winding. Since the structures of the frame 2 used for inner winding and outer winding are different, two types of structures are used respectively for the positioning part 21 and the mounting part 41.

In some preferred implementations, the above positioning part 21 includes a positioning groove 211, the mounting part 41 includes a mounting insert block 411, and the mounting insert block 411 is inserted into the positioning groove 211. In a specific application, the wire holder 4 can be fixedly mounted on the frame 2 quickly by the positioning groove 211 cooperating with the mounting insert block 411.

To firmly fix the wire holder 4 to the frame 2, in some preferred implementations, the above positioning part 21 further includes positioning plates 212, the mounting part 41 further includes mounting grooves 412, and the positioning plates 212 are inserted into the mounting grooves 412. The wire holder 4 is mounted on the frame 2 more firmly by the positioning plates 212 cooperating with the mounting grooves 412 and the positioning groove 211 cooperating with the mounting insert block 411. Specifically, a number of the above positioning plates 212 is two, and a number of the mounting grooves 412 is also two. The two positioning plates 212 are arranged on two sides of the positioning groove 211 respectively, and the two mounting grooves 412 are formed on two sides of the mounting insert block 411 respectively. Thus, when the wire holder 4 is mounted on the frame 2, the wire holder 4 can be subjected to a uniform force.

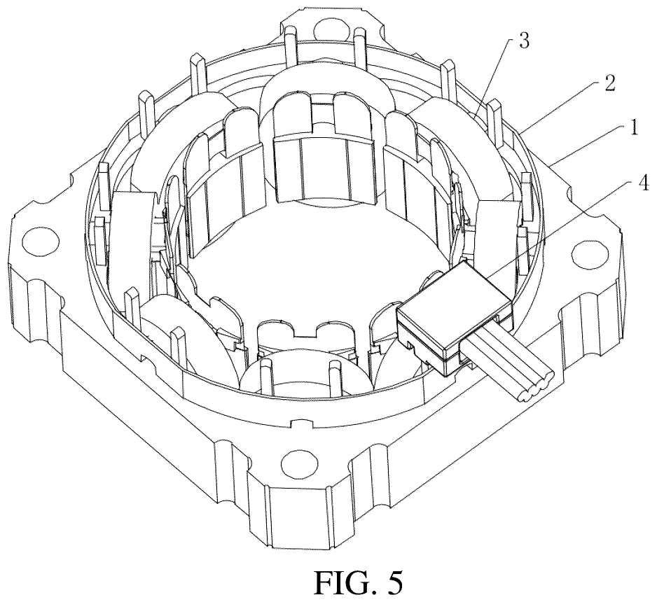

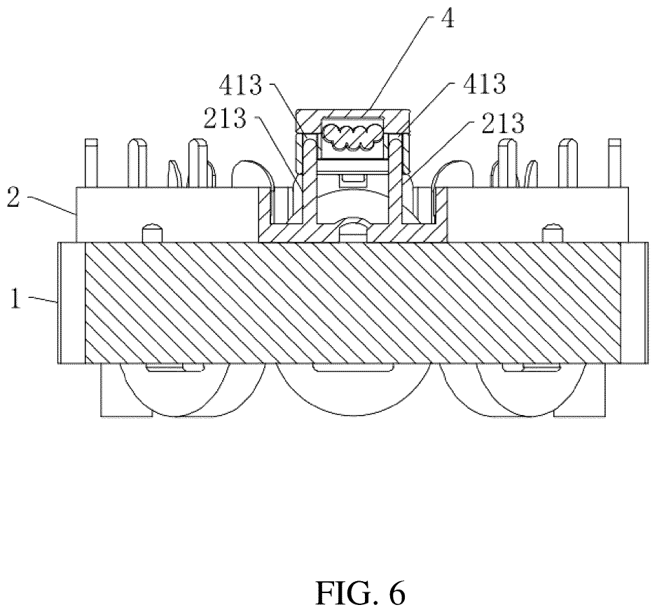

As shown in FIG. 5 and FIG. 6, in some other preferred implementations, the above positioning part 21 includes two positioning pins 213, the mounting part 41 includes two mounting holes 413, and the two positioning pins 213 are inserted into the two mounting holes 413 respectively. In a specific application, the wire holder 4 can be fixedly mounted on the frame 2 quickly by the positioning pins 213 cooperating with the mounting holes 413.

It can be understood that to make a wire holder 4 suitable to be mounted on two types of frames 2, the wire holder 4 may be provided with positioning parts 21 having two structures simultaneously.

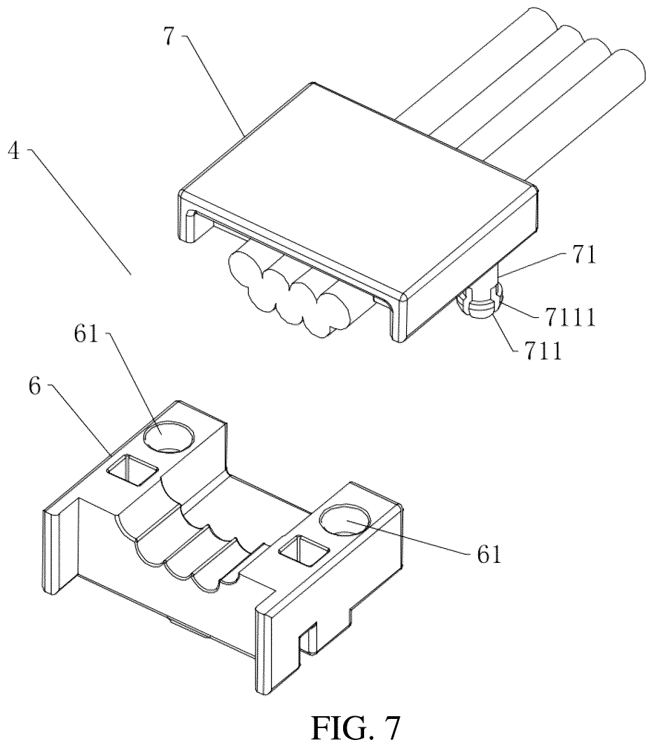

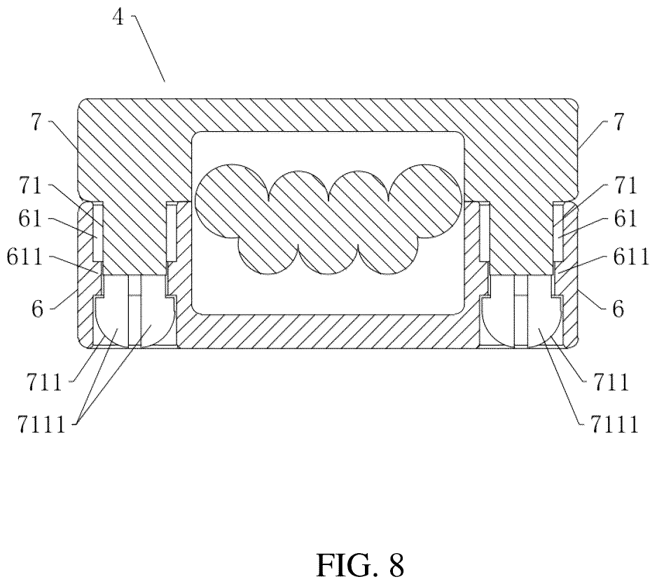

As shown in FIG. 7 and FIG. 8, in some preferred implementations, the above wire holder 4 includes a first holder 6 and a second holder 7 detachably connected to each other, and wire slots matching lead wires in shape are formed on one side of the first holder 6 and one side of the second holder 7 opposite to each other. In a specific application, by forming the wire slots matching the lead wires in shape on one side of the first holder 6 and one side of the second holder 7 opposite to each other, the lead wires can be fixed with the wire holder 4 quickly and easily.

In some preferred implementations, insertion holes 61 are formed in the above first holder 6, inserted pins 71 are arranged on the second holder 7, and the inserted pins 71 are inserted into the insertion holes 61. In a specific application, by forming the insertion holes 61 in the first holder 6 and arranging the inserted pins 71 on the second holder 7, the first holder 6 can be connected to the second holder 7 quickly by the inserted pins 71 cooperating with the insertion holes 61.

In some preferred implementations, inner walls of the above insertion holes 61 are provided with inwardly protruding blocking rings 611, ends of the inserted pins 71 away from the second holder 7 are provided with connecting heads 711, and the connecting heads 711 are clamped by the blocking rings 611. In a specific application, by arranging the inwardly protruding blocking rings 611 on the inner walls of the insertion holes 61, and arranging the connecting heads 711 at the ends of the inserted pins 71 away from the second holder 7, the first holder 6 can be firmly connected to the second holder 7 by the connecting heads 711 cooperating with the blocking rings.

In some preferred implementations, the above connecting heads 711 include multiple elastic connecting blocks 7111. When the connecting heads 711 pass through the blocking rings 611, the multiple connecting blocks 7111 can contract inward. In a specific application, by providing the connecting heads 711 with the multiple elastic connecting blocks 7111, the connecting heads 711 can pass through the blocking rings 611 easily.

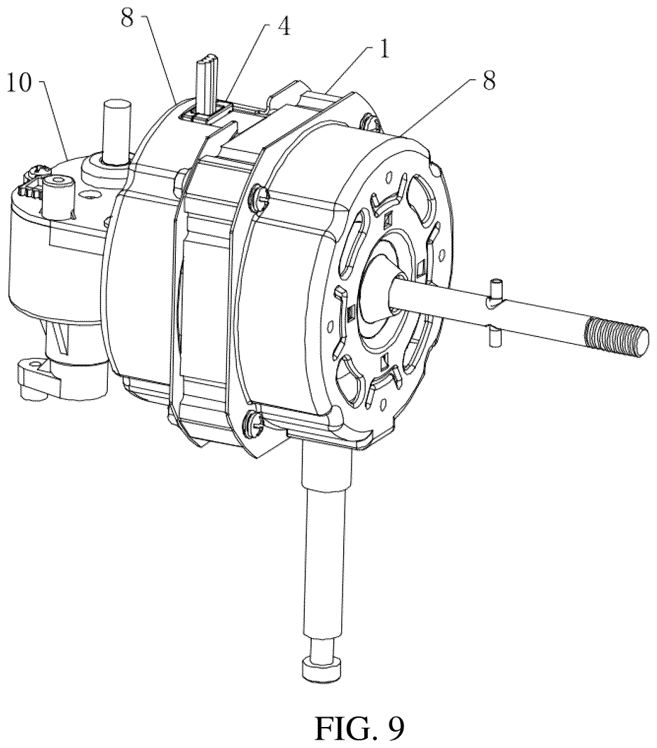

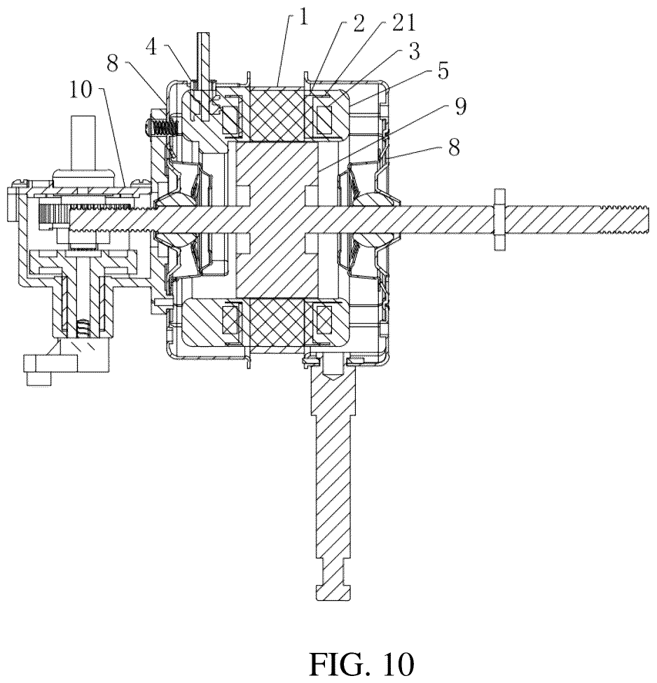

In a second aspect, as shown in FIG. 9 and FIG. 10, the present utility model provides a fan motor, including a housing 8, a rotor 9, and a oscillation gearbox 10, and the stator structure as described in the first aspect above. The housing 8 is arranged on the core 1 and covers the plastic package body 5. The rotor 9 is rotationally arranged on an inner side of the core 1. A shaft of the rotor 9 passes through the housing 8. The oscillation gearbox 10 is arranged on the housing 8 and connected to the shaft of the rotor 9.

In a specific application, the rotor 9 rotates to drive the shaft to rotate, so as to drive fan blades mounted on the shaft to rotate. During rotation of the fan blades, the fan blades may oscillate by adjusting the oscillation gearbox 10. Specifically, the oscillation gearbox 10 may use a structure in the prior art.

Based on the above, according to the stator structure and the fan motor provided by the present utility model, by arranging the positioning part 21 exposed from the core 1 at the edge of the frame 2, and also arranging the mounting part 41 matching the positioning part 21 on the wire holder 4, the wire holder 4 can be fixed to the frame 2, so that the wire holder 4 does not need to be pushed into the injection mold cavity manually during injection molding to ensure the quality of the stator structure.

The descriptions above are only some implementations of the present utility model. It will be apparent to those of ordinary skill in the art that various modifications and improvements can be made without departing from the creative concept of the present utility model, which all fall within the scope of protection of the present utility model.

What is claimed is:

1. A stator structure, comprising a core, a frame, a winding, a wire holder, and a plastic package body, wherein the frame is arranged on the core, the winding is wound on the frame, an edge of the frame is provided with a positioning part, the positioning part is exposed from the core, the wire holder is provided with a mounting part, the mounting part is mounted on the positioning part, and the plastic package body covers the core, the frame, the winding, and the wire holder.

2. The stator structure according to claim 1, wherein the positioning part comprises a positioning groove, the mounting part comprises a mounting insert block, and the mounting insert block is inserted into the positioning groove.

3. The stator structure according to claim 2, wherein the positioning part further comprises positioning plates, the mounting part further comprises mounting grooves, and the positioning plates are inserted into the mounting grooves.

4. The stator structure according to claim 3, wherein a number of the positioning plates is two, a number of the mounting grooves is also two, the two positioning plates are arranged on two sides of the positioning groove respectively, and the two mounting grooves are formed on two sides of the mounting insert block respectively.

5. The stator structure according to claim 1, wherein the positioning part comprises two positioning pins, the mounting part comprises two mounting holes, and the two positioning pins are inserted into the two mounting holes respectively.

6. The stator structure according to claim 1, wherein the wire holder comprises a first holder and a second holder detachably connected with each other, and wire slots matching lead wires in shape are formed on one side of the first holder and one side of the second holder opposite to each other.

7. The stator structure according to claim 6, wherein insertion holes are formed in the first holder, inserted pins are arranged on the second holder, and the inserted pins are inserted into the insertion holes.

8. The stator structure according to claim 7, wherein inner walls of the insertion holes are provided with inwardly protruding blocking rings, ends of the inserted pins away from the second holder are provided with connecting heads, and the connecting heads are clamped by the blocking rings.

9. The stator structure according to claim 8, wherein the connecting heads comprise a plurality of elastic connecting blocks, and when the connecting heads pass through the blocking rings, the plurality of connecting blocks are configured to contract inward.

10. A fan motor, comprising a housing, a rotor, and a reduction gearbox, and the stator structure according to claim 1, wherein the housing is arranged on the core and covers the plastic package body, the rotor is rotationally arranged on an inner side of the core, a shaft of the rotor passes through the housing, and the oscillation gearbox is arranged on the housing and connected to the shaft of the rotor.
